(19) United States
(12) Patent Application Publication
(10) Pub. No.: US 2026/0074228 A1
(43) Pub. Date: Mar. 12, 2026

(54) ANODE FOR SECONDARY BATTERY AND SECONDARY BATTERY INCLUDING THE SAME

(71) Applicant: SK ON CO., LTD., Seoul (KR)

(72) Inventors: Young Ju CHOI, Daejeon (KR); Kwang Ho JEONG, Daejeon (KR); Young Gil CHOI, Daejeon (KR)

(21) Appl. No.: 19/321,298

(22) Filed: Sep. 8, 2025

(30) Foreign Application Priority Data
Sep. 10, 2024 (KR) 10-2024-0123552

(51) Int. Cl. H01M 4/62; H01M 4/02; H01M 4/134; H01M 4/38

(52) U.S. Cl. CPC H01M 4/624; H01M 4/134; H01M 4/386; H01M 2004/027

(57) ABSTRACT

A secondary battery anode comprises an anode current collector, and an anode active material layer disposed on at least one surface of the anode current collector and comprising an anode active material, a binder, and a conductive additive, wherein the conductive additive comprises a conductive polymer and cellulose nanofibers (CNF). The secondary battery comprises the anode for the secondary battery and a cathode for the secondary battery facing the anode.

### CROSS-REFERENCES TO RELATED APPLICATION

The present application claims priority under 35 U.S.C. § 119(a) to Korean Patent Application Number 10-2024-0123552, filed on Sep. 10, 2024, which is incorporated herein by reference in its entirety.

### BACKGROUND OF THE INVENTION

### 1. Field of the Invention

The present disclosure relates to an anode for a secondary battery and a secondary battery including the anode.

### 2. Description of the Related Art

Secondary batteries arm batteries that can be repeatedly charged and discharged. With the development of the information, communication and display industries, secondary batteries have been widely applied as power sources for portable electronic communication devices, such as camcorders, mobile phones, and laptop PCs. In addition, battery packs including the secondary batteries have recently been developed and applied as power sources for eco-friendly vehicles, such as hybrid cars.

Examples of the secondary battery may include a lithium secondary battery, a nickel-cadmium battery, a nickel-hydrogen battery and the like. Among them, the lithium secondary battery has a high operating voltage and ahigh energy density per unit weight, making it advantageous in terms of charging speed and weight reduction, such that development thereof is progressing in this regard.

The lithium secondary battery may include a cathode and an anode. The electrodes, such as the cathode and the anode, may include an electrode active material capable of reversibly intercalating and deintercalating lithium ions, and may generate current through a chemical reaction at the electrodes. Carbon-based materials, silicon-based materials, and the like may be used as an active material for the anode.

The volume of an anode active material layer may expand during the charging and discharging process of the secondary battery. In this case, the contact between a conductive material and the active material may deteriorate, and the electrical conductivity of the anode active material layer may decrease.

### SUMMARY OF THE INVENTION

An object of the present disclosure is to provide an anode for a secondary battery with improved electrical characteristics and cycle life characteristics.

Another object of the present disclosure is to provide a secondary battery with improved electrical characteristics and cycle life characteristics.

An anode for a secondary battery according to exemplary embodiments of the present disclosure includes: an anode current collector; and an anode active material layer disposed on at least one surface of the anode current collector and including an anode active material, a binder and a conductive additive, wherein the conductive additive includes a conductive polymer and cellulose nanofibers (CNF).

In some embodiments, the cellulose nanofibers may have a diameter of 1 nm to 15,000 nm.

In some embodiments, some of the hydroxyl groups included in the cellulose nanofibers may be substituted with hydrophilic functional groups.

In some embodiments, the hydrophilic functional groups may include carboxyl groups.

In some embodiments, the degree of substitution of the cellulose nanofibers may be 0.01 to 0.5.

In some embodiments, the conductive polymer may include at least one selected from the group consisting of poly(3,4-ethylenedioxythiophene) (PEDOT), polyacetylene (PA), polypyrrole (PPy), polythiophene (PT), polyphenylene sulfide (PPS), poly(p-phenylene vinylene) (PPV) and polyaniline (PANI).

In some embodiments, the ratio of weight of the conductive polymer to the weight of the cellulose nanofibers may be 0.02 to 1.

In some embodiments, the content of the conductive additive may be 0.1 wt % to 5 wt % based on the total weight of the anode active material layer.

In some embodiments, the anode active material may include a silicon-based active material.

In some embodiments, the anode active material layer may further include a conductive material.

In some embodiments, the conductive material may include carbon nanotubes (CNTs).

In some embodiments, the content of the conductive material may be 0.01 wt % to 2 wt % based on the total weight of the anode active material layer.

A secondary battery according to exemplary embodiments of the present disclosure includes: the above-described anode for a secondary battery; and a secondary battery cathode disposed to face the anode for the secondary battery.

According to an embodiment of the present disclosure, a conductive network may be formed by providing a pathway for electron migration between the conductive material and the anode active material. Therefore, the electrical characteristics and capacity characteristics of the anode for a secondary battery may be improved.

According to an embodiment of the present disclosure, the adhesion strength within the anode active material layer may be improved, thereby suppressing deformation of the anode for a secondary battery due to expansion of the anode active material.

The anode for a secondary battery according to the embodiments of the present disclosure and the secondary battery including the same may be widely applied in green technology fields, such as electric vehicles, battery charging stations, as well as solar power generation, wind power generation, and the like, which use the batteries. In addition, the anode for a secondary battery according to the embodiments of the present disclosure and the secondary battery including the same may be used in eco-friendly electric vehicles, hybrid vehicles, and the like, which am aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating an anode for a secondary battery according to exemplary embodiments; and

FIGS. 2 and 3 arm schematic plan and cross-sectional views illustrating a secondary battery according to exemplary embodiments, respectively.

### DETAILED DESCRIPTION OF THE INVENTION

Embodiments of the present disclosure provide an anode for a secondary battery including a conductive additive.

In addition, embodiments of the present disclosure provide a secondary battery including the anode for the secondary battery.

Hereinafter, the embodiments of the present disclosure will be described in detail with reference to the accompanying drawings. However, the drawings attached to the present disclosure am merely illustrative of exemplary embodiments of the present disclosure to aid in understanding the technical spirit of the invention together with the foregoing description, and should not be construed as being limited to the matters illustrated in such drawings.

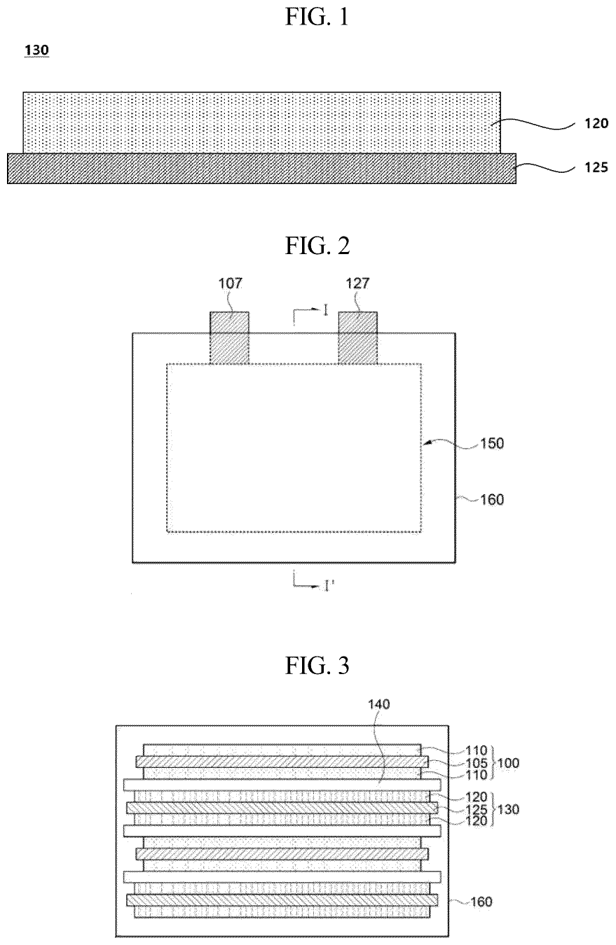

FIG. 1 is a schematic cross-sectional view illustrating an anode for a secondary battery (hereinafter, also be abbreviated as an anode) according to exemplary embodiments.

Referring to FIG. 1, an anode 130 includes an anode current collector 125 and an anode active material layer 120 disposed on at least one surface of the anode current collector 125.

In some embodiments, the anode active material layer 120 may be formed on both surfaces (e.g., upper and lower surfaces) of the anode current collector 125.

In some embodiments, the anode current collector 125 may include gold, stainless steel, nickel, aluminum, titanium, copper, or an alloy thereof. For example, the anode current collector 125 may include copper or a copper alloy.

The anode active material layer 120 may include an anode active material, a binder and a conductive additive.

For example, an anode slurry including the anode active material, the binder and the conductive additive may be coated on the anode current collector 125 to form the anode active material layer 120.

In the embodiments of the present disclosure, the conductive additive may include a conductive polymer and cellulose nanofibers (CNF).

The conductive polymer may refer to a polymer having electrical conductivity. A pathway for electron migration may be provided by the conductive polymer. As the conductive additive is included in the anode active material layer 120, a pathway for electron migration within the anode active material layer 120 may be supplemented, and a conductive network may be formed.

According to exemplary embodiments, the conductive polymer may include at least one selected from the group consisting of poly(3,4-ethylenedioxythiophene) (PEDOT), polyacetylene (PA), polypyrrole (PPy), polythiophene (PT), polyphenylene sulfide (PPS), poly(p-phenylene vinylene)(PPV), and polyaniline (PANI). These may be used alone or in combination of two or more thereof.

For example, the conductive polymer may include poly(3,4-ethylenedioxythiophene)(PEDOT), polythiophene (PT), or polyphenylene sulfide (PPS). For example, the conductive polymer may include poly(3,4-ethylenedioxythiophene)(PEDOT).

The conductive polymer may provide a pathway for electron migration between the anode active material and the conductive material, thereby decreasing the resistance of the anode 130. Accordingly, stable electrical conductivity may be achieved in the anode 130, thereby improving the electrical characteristics and cycle life characteristics of the anode 130.

According to some embodiments, the conductive polymer may be electrostatically bonded to the cellulose nanofibers (CNF). For example, the cellulose nanofibers may provide electrostatic bonding between the molecular units of the conductive polymer.

For example, the conductive additive may be formed by electrostatically bonding the cellulose nanofibers to the conductive polymer. Accordingly, the dispersibility of the conductive additive within the solvent or the anode slurry may be improved. As a result, the conductive additive may be uniformly dispersed in the anode active material layer 120, thereby providing a uniform pathway for electron migration.

The cellulose nanofibers (CNF) may include a cellulose polymer in the form of a fiber having a small diameter and along length. The fiber may have a thin and long thread shape. The diameter of the fiber may refer to the diameter of a cross-section perpendicular to the longitudinal direction of the fiber. The cellulose polymer in the form of a fiber may have improved adhesiveness and bonding due to high mechanical strength and high surface ama.

As the cellulose nanofibers (CNF) may be included in the conductive additive, adhesion between the anode active material and the conductive additive may be enhanced. Accordingly, the mechanical stability may be further improved while the pathway for election migration within the anode active material layer 120 is stably maintained during repeated charging and discharging. Accordingly, the cycle life characteristics, efficiency, and capacity characteristics of the secondary battery may be further improved.

In exemplary embodiments, the cellulose nanofibers (CNF) may have a diameter of 1 nm to 15,000 nm, 10 nm to 600 nm, or 20 nm to 50 nm. Within the above range, the mechanical strength and adhesiveness of the cellulose nanofibers (CNF) may be further improved. Accordingly, the dispersibility of the conductive additive may be improved, and the electrical characteristics and cycle life characteristics of the anode 130 may be enhanced.

In some embodiments, the cellulose nanofibers (CNF) may have a length of 0.5 μm to 5 μm. Within the above range, the mechanical stability and electrical characteristics of the anode 130 may be further improved.

In exemplary embodiments, some of the hydroxyl groups (—OH) included in the cellulose nanofibers (CNF) may be substituted with hydrophilic functional groups.

The cellulose nanofibers (CNF) may include cellulose molecules polymerized with multiple glucose units as repeating units. The glucose unit may include hydroxyl groups (—OH) as functional groups. In some embodiments, the hydrogen of the hydroxyl group may be substituted with another functional group. For example, the glucose unit may include an alkoxy group (—OR).

In some embodiments, the glucose unit may include a hydrophilic functional group as the —R group of the —OR group. The hydrophilic functional group may include, for example, a carboxyl group, amino group, cyano group, nitro group, ether group, amide group, sulfonic acid group, phosphoric acid group, or aldehyde group. Accordingly, the hydrophilicity of the cellulose nanofibers may increase, thereby improving the dispersibility of the conductive additive in water or a solvent.

In exemplary embodiments, the hydrophilic functional group may include a carboxyl group (—COOH). For example, the glucose unit may include a carboxyl group (—COOH) as the —R group of the —OR group.

In exemplary embodiments, the degree of substitution (DS) of the cellulose nanofibers (CNF) may be 0.01 to 0.5, 0.1 to 0.5, or 0.2 to 0.4.

The degree of substitution may refer to the extent to which the hydroxyl groups of the glucose units are substituted with other functional groups. For example, the degree of substitution may be calculated as an average number of substituent groups per repeating unit of the glucose unit.

As the degree of substitution increases, the adhesiveness of the cellulose nanofibers may become excessively high. As the degree of substitution decreases, the dispersibility of the conductive additive in the solvent may decrease. Within the above range, the dispersibility and adhesiveness of the conductive additive may be further improved. Accordingly, the electrical characteristics and cycle life characteristics of the anode 130 may be enhanced.

According to exemplary embodiments, the content of the conductive polymer among the conductive additives may be less than or equal to the content of the cellulose nanofibers (CNF). For example, the content of the conductive polymer may be lower than the content of the cellulose nanofibers (CNF). Accordingly, the content of the cellulose nanofibers (CNF) among the conductive additives may relatively increase, thereby improving the structural stability and cycle life characteristics of the anode 130.

In exemplary embodiments, the ratio of weight of the conductive polymer to the weight of the cellulose nanofibers (CNF) may be 0.01 to 1, 0.02 to 1, 0.03 to 1, or 0.1 to 1. Within the above range, the dispersibility of the conductive additive may be improved, allowing a more uniform formation of a conductive network, while further reducing the internal resistance of the anode 130. Accordingly, the electrical characteristics and structural stability of the anode active material layer 120 may be improved.

In exemplary embodiments, the content of the conductive additive may be 0.1% by weight (“wt %”) to 5 wt %, or 0.1 wt % to 1 wt % based on the total weight of the anode active material layer 120.

For example, as the content of the conductive additive increases, the conductive additive and the binder may aggregate to form fine particles in the anode slurry. Accordingly, the cycle life characteristics of the secondary battery may deteriorate. Within the above range, the electrical characteristics and cycle life characteristics of the secondary battery may be further enhanced.

As the anode active material, a material capable of intercalating and deintercalating lithium ions may be used. For example, as the anode active material, carbon-based materials such as crystalline carbon, amorphous carbon, carbon composite, or carbon fibers, etc.; lithium metal; a lithium alloy; a silicon (Si)-containing material or a tin (Sn)-containing material, etc. may be used. These may be used alone or in combination of two or more thereof.

The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal having a protective layer formed thereon for suppressing dendrite growth and the like. In one embodiment, a lithium metal-containing layer deposited or coated on the anode current collector 135 may be used as the anode active material layer 120. In one embodiment, a lithium thin film layer may also be used as the anode active material layer 120.

Flements contained in the lithium alloy may include aluminum, zinc, bismuth, cadmium, antimony, silicon, lead, tin, gallium, indium, etc. These may be used alone or in combination of two or more thereof.

In exemplary embodiments, the anode active material may include a silicon-based active material. The silicon-based active material may refer to an active material including a silicon (Si) element. Therefore, the capacity characteristics and output characteristics of the anode 130 may be improved.

The silicon compound may include silicon, silicon oxide (SiOₓ, 0<x<2), or a silicon-carbon composite compound such as silicon carbide (SiC). These may be used alone or in combination of two or more thereof. For example, the anode active material may include silicon oxide (SiOₓ, 0≤x≤2).

In some embodiments, the anode active material layer 120 may include a silicon-based active material having a low electrical conductivity, thereby educing the electrical conductivity of the anode 130. By including the conductive additive in the anode active material layer 120, the pathway for electron migration within the anode active material layer 120 may be supplemented, and a conductive network may be formed. Accordingly, the electrical characteristics and cycle life characteristics of the secondary battery may be further improved.

The silicon-based active material may have a high volume expansion/contraction rate. The anode active material layer 120 may include the silicon-based active material, thereby allowing a large volume change in the anode active material layer 120 during repeated charging and discharging.

According to embodiments of the present disclosure, by including the cellulose nanofibers (CNF) in the anode active material layer 120, the volume change of the silicon-based active material may be suppressed. For example, the cellulose nanofibers (CNF) may maintain adhesion between the conductive additive and the silicon-based active material, as well as between the silicon-based active material and the anode current collector 125. Therefor, the volume change of the anode active material layer 120 may be suppressed, thereby improving the cycle life characteristics of the anode 130.

The anode active material according to some embodiments may include both the carbon-based active material and the silicon-based active material. Therefore, the capacity of the anode 130 may be improved while the expansion of the anode 130 is buffered by the carbon-based active material.

In some embodiments, the binder may be an aqueous binder. For example, a styrene-butadiene rubber (SBR)-based binder, carboxymethyl cellulose (CMC), polyacrylic acid-based binder (PAA), poly(3,4-ethylenedioxythiophene (PEDOT)-based binder, and the like may be used as an anode binder. These may be used alone or in combination of two or more thereof.

For example, styrene-butadiene rubber (SBR) or carboxymethyl cellulose (CMC) may be used. Accordingly, adhesion with the cellulose nanofibers in the anode slurry may be further enhanced.

In exemplary embodiments, the anode active material layer 120 may further include a conductive material. Accordingly, the resistance of the anode 130 may be reduced, thereby further improving the initial efficiency and output characteristics of the secondary battery.

The conductive material may include carbon-based conductive materials such as graphite, carbon black, acetylene black, Ketjen black, graphene, carbon nanotubes, vapor-grown carbon fibers (VGCFs), carbon fibers, and/or metal-based conductive materials, including perovskite materials, such as tin, tin oxide, titanium oxide, LaSrCoO₃, and LaSrMnO₃. These may be used alone or in combination of two or more thereof.

In exemplary embodiments, the conductive material may include carbon nanotubes (CNTs). For example, the carbon nanotubes (CNTs) may include single-walled carbon nanotubes (SWCNTs) and/or multi-walled carbon nanotubes (MWCNTs).

In some embodiments, the conductive material may include multi-walled carbon nanotubes (MWCNTs). The inclusion of multi-walled carbon nanotubes (MWCNTs) may suppress an increase in the interfacial resistance of the anode 130 caused by the expansion of the anode active material layer 120. Accordingly, the electrical characteristics and cycle life characteristics of the secondary battery may be further improved.

In some embodiments, the content of the conductive material may be 0.01 wt % to 2 wt %, 0.05 wt % to 2 wt %, 0.1 wt % to 1 wt %, or 0.3 wt % to 0.7 wt % based on the total weight of the anode active material layer 120. Within the above range, the high-capacity characteristics and electrical characteristics of the anode 130 may be further improved.

For example, when the content of the conductive material is increased to enhance the electrical conductivity of the anode 130, the capacity of the anode 130 may decrease.

According to exemplary embodiments of the present disclosure, by including the conductive additive in the anode active material layer 120, the pathway for election migration within the anode 130 may be supplemented. Therefore, even if the content of the conductive material is reduced, the high-capacity characteristics and electrical characteristics of the anode 130 may be enhanced.

A secondary battery according to exemplary embodiments of the present disclosure includes the above-described anode 130.

FIGS. 2 and 3 are schematic plan and cross-sectional views illustrating the secondary battery according to exemplary embodiments, respectively.

Referring to FIGS. 2 and 3, the secondary battery may include the anode 130 and a cathode 100 disposed to face the anode 130.

The cathode 100 may include a cathode current collector 105, and a cathode active material layer 110 formed on at least one surface of the cathode current collector 105.

The cathode current collector 105 may include stainless steel, nickel, aluminum, titanium or an alloy thereof. The cathode current collector 105 may also include aluminum or stainless steel having a surface treated with carbon, nickel, titanium or silver. For example, the cathode current collector 105 may have a thickness of 10 to 50 μm.

The cathode active material layer 110 may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

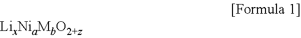

In Formula 1, x, a, band z may satisfy 0.9≤x≤1.2, 0.6≤a≤0.99, 0.01≤b≤0.4, and −0.5≤z≤0.1. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form a bond, and it should be understood that this case is also included within the chemical structure range represented by Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may act as an auxiliary active element which contributes to the capacity/output activity of the cathode active material together with Co or Mn, such as Al.

For example, the cathode active material or the lithium-nickel metal oxide may include a layered structure or a crystal structure represented by Formula 1-1 below.

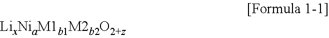

In Formula 1-1, M1 may include Co, Mn and/or Al. M2 may include the above-described auxiliary elements. In Formula 1-1, x, a, b1, b2 and z may satisfy 0.9≤x≤1.2, 0.6≤a≤0.99, 0.01≤b1+b2≤0.4, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium-nickel metal oxide particles, or may penetrate through the surface of the lithium-nickel metal composite oxide particles to become incorporated into the bonding structure represented by Formula 1 or Formula 1-1 above.

The cathode active material may include a nickel-cobalt-manganese (NCM)-based lithium oxide. In this case, an NCM-based lithium oxide with an increased content of nickel may be used.

Nickel may be provided as a transition metal associated with the output and capacity of the lithium secondary battery. Therefor, as described above, by employing a high-nickel-content (high-Ni) composition in the cathode active material, ahigh-capacity cathode and ahigh-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity.

The content of Ni (e.g., the molar fraction of nickel based on the total moles of nickel, cobalt and manganese) in the NCM-based lithium oxide may be 0.5 or more, 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, an Li-rich layered oxide (LLO)/over lithiated oxide (OLO)-based active material, an Mn-rich-based active material, or a Co-less active material, each having a chemical structure or crystal structure represented by Formula 2. These may be used alone or in combination of two or more thereof.

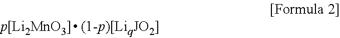

In Formula 2, p and q may satisfy 0<p<1, and 0.9≤q≤1.2, and J may include at least one element among Mn, Ni, Co, Fe, Cr, V, Cu, Zn, Ti, Al, Mg and B.

The cathode active material may be mixed in a solvent to prepare a cathode slurry. The cathode slurry may be applied to at least one surface of the cathode current collector 105, followed by drying and roll-pressing to prepare the cathode active material layer 110. The coating may include a method such as gravure coating, slot die coating, simultaneous multilayer die coating, imprinting, doctor blade coating, dip coating, bar coating or casting. The cathode active material layer 110 may further include a binder, and optionally further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may be decreased and the amount of the cathode active material may be relatively increased. Accordingly, the output characteristics and capacity characteristics of the secondary battery may be improved.

The conductive material may be added to the cathode active material layer 110 in order to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCFs), carbon fibers, and/or metal-based conductive materials, including perovskite materials, such as tin, tin oxide, titanium oxide, LaSrCoO₃, and LaSrMnO₃. These may be used alone or in combination of two or more thereof.

The cathode slurry may further include a thickener and/or dispersant. In one embodiment, the cathode slurry may include a thickener such as carboxymethylcellulose (CMC).

As described above, the anode 130 may include the anode current collector 125, and the anode active material layer 120 formed on at least one surface of the anode current collector 125.

The solvent included in the anode slurry may include water, pure water, deionized water, distilled water, ethanol, isopropanol, methanol, acetone, n-propanol, t-butanol and the like. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow the flow of ions. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having ahigh melting point, polyethylene terephthalate fibers, etc.

The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, an electrode cell may be defined by the cathode 100, the anode 130 and the separation membrane 140, and a plurality of electrode cells may be stacked to form, for example, a jelly roll type electrode assembly 150. For example, the electrode assembly 150 may be formed by winding, stacking, z-folding, or stack-folding the separation membrane 140.

The electrode assembly 150 may be accommodated in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethylcarbonate (DEC), dimethylcarbonate (DMC), ethylmethylcarbonate (EMC), methyl propyl carbonate, ethylpropyl carbonate, dipropyl carbonate, vinylene carbonate, methyl acetate (MA), ethylacetate (EA), n-propylacetate (n-PA), 1,1-dimethylethylacetate (DMEA), methylpropionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrfuran (THF), 2-methyltetrahydrofuran, ethyl alcohol, isopropyl alcohol, dimethyl sulfoxide, acetonitrile, diethoxyethane, sulfolane, gamma-butyrolactone, and propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluormethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato)phosphate, lithium difluoro phosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂—LiₚMO_{q} (p and q am positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 2 and 3, electrode tabs (cathode tabs and anode tabs) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### EXAMPLES AND COMPARATIVE EXAMPLES

### Example 1

### (1) Preparation of Conductive Additive (PEDOT:CNF)

Ethylenedioxythiophene (EDOT) monomer, cellulose nanofibers (CNF)(degree of substitution: 0.3, diameter: 30 nm, Hansol Paper Co., Duracle A), and ion (I) chloride as an oxidant were mixed to prepare a reaction mixture. The reaction mixture was dissolved in water and stirred for 24 hours to prepare PEDOT:CNF.

### (2) Fabrication of Anode for a Secondary Battery

An anode slurry was prepared by mixing 86.5 wt % of carbon-based active material as an anode active material, 10.0 wt % of silicon oxide (SiOx), 0.5 wt % of multi-walled carbon nanotubes (MWCNTs) as a conductive material, 1.2 wt % of carboxymethyl cellulose (CMC) and 1.3 wt % of styrene-butadiene rubber (SBR) as binder materials, and 0.5 wt % of PEDOT:CNF prepared in (1). The anode slurry was coated on a copper substrate, followed by drying and roll-pressing to fabricate an anode.

### (3) Manufacture of Secondary Battery

Li[Ni_{0.6}Co_{0.2}Mn_{0.2}]O₂ as a cathode active material, carbon black as a conductive material, and polyvinylidene fluoride (PVdF) as a binder were mixed in a weight ratio of 96.5:2:1.5 to prepare a slurry. The slurry was uniformly applied to an aluminum foil with a thickness of 12 μm, and vacuum-died at 130° C. to fabricate a cathode.

The fabricated cathode and anode were notched to appropriate sizes and stacked, and a separation membrane (polyethylene, thickness: 13 μm) was interposed between the cathode and the anode.

1M LiPF₆ was dissolved in a mixed solvent of EC/EMC/DEC (25/45/30; volume ratio), and 1 wt % of vinylene carbonate (VC), 0.5 wt % of 1,3-propenesultone (PRS), and 0.5 wt % of lithium bis(oxalato)borate (LiBOB) were added to the mixture to prepare an electrolyte.

An assembly of the cathode/separation membrane/anode was placed in a pouch, and the electrolyte was injected into the pouch and allowed to impregnate for 12 hours or more to manufacture a secondary battery.

### Examples 2 to 10

Secondary batteries were manufactured in the same manner as in Example 1, except that the degree of substitution and diameter of cellulose nanofibers (CNF) we adjusted as described in Table 1.

TABLE 1

| | | | Cellulose nanofibers (CNF) | |
|---|---|---|---|---|
| | Conductive additive | | Degree of | |
| | | Content | substitution | Diameter |
| Classification | Type | (wt %) | (DS) | of CNF (nm) |
| Example 1 | PEDOT:CNF | 0.5 | 0.3 | 30 |
| Example 2 | PEDOT:CNF | 0.5 | 0.3 | 500 |
| Example 3 | PEDOT:CNF | 0.5 | 0.3 | 10,000 |
| Example 4 | PEDOT:CNF | 0.5 | 0.3 | 0.5 |
| Example 5 | PEDOT:CNF | 0.5 | 0.3 | 20,000 |
| Example 6 | PEDOT:CNF | 0.5 | 0.5 | 30 |
| Example 7 | PEDOT:CNF | 0.5 | 0.1 | 30 |
| Example 8 | PEDOT:CNF | 0.5 | 0 | 30 |
| Example 9 | PEDOT:CNF | 0.5 | 0.005 | 30 |
| Example 10 | PEDOT:CNF | 0.5 | 0.8 | 30 |

### Comparative Example 1

An anode slurry was prepared by mixing 87 wt % of a carbon-based active material as an anode active material, 10.0 wt % of silicon oxide (SiOx), 0.5 wt % of multi-walled carbon nanotubes (MWCNTs) as a conductive material, 1.2 wt % of carboxymethyl cellulose (CMC) as a binder material, and 1.3 wt % of styrene-butadiene rubber (SBR). The anode slurry was coated on a copper substrate, followed by drying and roll-pressing to fabricate an anode.

The manufacture of the cathode and the secondary battery was performed in the same manner as in Example 1.

### Comparative Example 2

A secondary battery was manufactured in the same manner as in Example 1, except that polystyrene sulfonic acid (PSS) was used instead of cellulose nanofibers (CNF) during the preparation of the conductive additive.

### Comparative Example 3

A secondary battery was manufactured in the same manner as in Example 1, except that polyacrylic acid (PAA) was used instead of cellulose nanofibers (CNF) during the preparation of the conductive additive.

### Comparative Example 4

A secondary battery was manufactured in the same manner as in Example 1, except that carboxymethyl cellulose (CMC) was used instead of cellulose nanofibers (CNF) during the preparation of the conductive additive.

The degree of substitution of carboxymethyl cellulose (CMC) was adjusted to 0.6.

### Experimental Example

### (1) Evaluation of Adhesion Strength of the Anode

The anodes according to the examples and comparative examples were cut into sizes of 18 mm in width and 150 mm in length to prepare samples. A tape having a width of 18 mm was attached to one side of the anode current collector of each sample, and was pressed using a roller having a load of 2 kg. Thereafter, the anode active material layer was adhered to one side of a tensile tester (IMADA, DS2-50N) using a double-sided tape.

The tape attached to the anode current collector was fastened to the other side of the tensile tester, and the tensile tester was moved at a speed of 300 rpm in the vertical direction of the bonding surface, and the anode adhesion strength (N/18 mm) was measured.

### (2) Evaluation of Capacity Retention

500 cycles of charging at 1/3 C within an SOC range of 4 to 98% and discharging at 0.5 C were repeated for the secondary batteries according to the examples and comparative examples in a chamber maintained at 25° C. The capacity retention was measured as the percentage (%) of the discharge capacity after the 500th cycle relative to the initial discharge capacity.

The results are shown in Table 2 below.

TABLE 2

Electrode/cell characteristic

| | Adhesion strength of anode | Capacity retention |
|---|---|---|
| Classification | (N/18 mm) | (%, at 500 cycles) |
| Example 1 | 0.62 | 92.4 |
| Example 2 | 0.42 | 91.9 |
| Example 3 | 0.62 | 90.3 |
| Example 4 | 0.63 | 86.5 |
| Example 5 | 0.54 | 83.1 |
| Example 6 | 0.63 | 92.2 |
| Example 7 | 0.6 | 89.8 |
| Example 8 | 0.38 | 82.8 |
| Example 9 | 0.42 | 83 |
| Example 10 | 0.4 | 83.1 |
| Comparative | 0.43 | 83.3 |
| Example 1 | | |
| Comparative | 0.41 | 86.1 |
| Example 2 | | |
| Comparative | 0.4 | 85.8 |
| Example 3 | | |
| Comparative | 0.45 | 85.0 |
| Example 4 | | |

Referring to Table 2 above, in the case of the examples, which included a conductive additive containing cellulose nanofibers in the anode, the adhesion strength and cycle life characteristics of the anode were improved.

In Examples 1 to 3, where the diameter of the cellulose nanofibers was in the range of 1 nm to 15,000 nm, the adhesion strength of the anode was improved compared to the other examples.

In Examples 1 to 7, where the degree of substitution of the cellulose nanofibers was in the range of 0.1 to 0.5, the adhesion strength and cycle life characteristics of the anode were further improved.

In the case of Comparative Example 1, the cycle life characteristics were significantly degraded compared to the examples due to the absence of the conductive additive.

In the case of Comparative Examples 2 and 3, the adhesion strength and capacity retention were slightly increased compared to Comparative Example 1 due to the inclusion of a conductive additive. However, improvements in adhesion strength and capacity retention were not significant.

In the case of Comparative Example 4, which included carboxymethyl cellulose (CMC), both the adhesion strength and the cycle life characteristics were degraded compared to Example 1.

### DESCRIPTION OF REFERENCE NUMERALS

100: Cathode
105: Cathode current collector
110: Cathode active material layer
120: Anode active material layer
125: Anode current collector
130: Anode
140: Separation membrane
160: Case

What is claimed is:

1. An anode for a secondary battery comprising:
an anode current collector, and
an anode active material layer disposed on at least one surface of the anode current collector and comprising an anode active material, a binder and a conductive additive,
wherein the conductive additive comprises a conductive polymer and cellulose nanofibers (CNF).

2. The anode for a secondary battery according to claim 1, wherein the cellulose nanofibers have a diameter of 1 nm to 15,000 nm.

3. The anode for a secondary battery according to claim 1, wherein some of the hydroxyl groups included in the cellulose nanofibers are substituted with hydrophilic functional groups.

4. The anode for a secondary battery according to claim 3, wherein the hydrophilic functional groups comprise carboxyl groups.

5. The anode for a secondary battery according to claim 3, wherein the degree of substitution of the cellulose nanofibers is 0.01 to 0.5.

6. The anode for a secondary battery according to claim 1, wherein the conductive polymer comprises at least one selected from the group consisting of poly(3,4-ethylenedioxythiophene) (PEDOT), polyacetylene (PA), polypyrrole (PPy), polythiophene (PT), polyphenylene sulfide (PPS), poly(p-phenylene vinylene)(PPV) and polyaniline (PAN).

7. The anode for a secondary battery according to claim 1, wherein the ratio of weight of the conductive polymer to the weight of the cellulose nanofibers is 0.02 to 1.

8. The anode for a secondary battery according to claim 1, wherein the content of the conductive additive is 0.1 wt % to 5 wt % based on the total weight of the anode active material layer.

9. The anode for a secondary battery according to claim 1, wherein the anode active material comprises a silicon-based active material.

10. The anode for a secondary battery according to claim 1, wherein the anode active material layer further comprises a conductive material.

11. The anode for a secondary battery according to claim 10, wherein the conductive material comprises carbon nanotubes (CNTs).

12. The anode for a secondary battery according to claim 10, wherein the content of the conductive material is 0.01 wt % to 2 wt % based on the total weight of the anode active material layer.

13. A secondary battery comprising:
the anode for a secondary battery according to claim 1; and
a secondary battery cathode disposed to face the anode for the secondary battery.
